(19) United States
(12) Patent Application Publication
(10) Pub. No.: US 2025/0055201 A1
(43) Pub. Date: Feb. 13, 2025

(54) ELECTROMAGNETIC WAVE REFLECTING DEVICE, ELECTROMAGNETIC WAVE REFLECTING FENCE, AND REFLECTION PANEL

(71) Applicant: AGC Inc., Tokyo (JP)

(72) Inventor: Kumiko KAMBARA, Tokyo (JP)

(73) Assignee: AGC Inc., Tokyo (JP)

(21) Appl. No.: 18/923,582

(22) Filed: Oct. 22, 2024

Related U.S. Application Data
(63) Continuation of application No. PCT/JP2023/017289, filed on May 8, 2023.

(30) Foreign Application Priority Data
Jun. 1, 2022 (JP) 2022-089848

(51) Int. Cl. H01Q 15/00

(52) U.S. Cl. CPC H01Q 15/0026

(57) ABSTRACT

An electromagnetic wave reflecting device includes a reflection panel configured to reflect radio waves in a desired band selected from a band of frequencies equal to or higher than 1 GHz and equal to or lower than 170 GHz, and a frame that holds the reflection panel. The reflection panel includes: a dielectric layer; a periodic conductive pattern provided on one surface of the dielectric layer; a ground layer provided on the other surface of the dielectric layer; a first intermediate layer covering the conductive pattern; a first dielectric substrate bonded to the conductive pattern by the first intermediate layer; a second intermediate layer covering the ground layer; and a second dielectric substrate bonded to the ground layer by the second intermediate layer.

### CROSS-REFERENCE TO RELATED APPLICATIONS

This application is a continuation application of International Application No. PCT/JP2023/017289 filed on May 8, 2023, and designated the U.S., which is based upon and claims priority to Japanese Patent Application No. 2022-089848 filed on Jun. 1, 2022, the entire contents of which are incorporated herein by reference.

### TECHNICAL FIELD

The present invention relates to an electromagnetic wave reflecting device, an electromagnetic wave reflecting fence, and a reflection panel.

### BACKGROUND

While high-speed and large-capacity communication is expected in the fifth-generation (hereinafter “5G”) mobile communication standard, there may be places where radio waves are difficult to reach due to a use of radio waves having high straight-line propagation properties. A means for delivering radio waves to a target terminal device or radio equipment is demanded in a place where many metal machines exist, such as a factory, or in a place where there are many reflections on wall surfaces or roadside trees, such as a street high-rise office buildings. A similar demand exists in a non-line-of-sight (NLOS) spot where no sight of a base station antenna can be obtained occurs, such as a medical site, an event venue, large commercial facilities, and the like.

In recent years, reflective surfaces with artificial surfaces called “metasurfaces” have been developed. A metasurface consists of a periodic structure or pattern finer than a wavelength, and is designed to reflect radio waves in a desired direction (for example, see Diaz-Rubio et al., Sci. Adv. 2017:3: e1602714 1). A metasurface itself is realized by a periodically repeated fine structure or metal pattern; in actual manufacturing of metasurfaces, a metal pattern is often provided on one surface of a dielectric substrate, and a ground layer is often provided on the opposite surface.

A metal pattern and a ground layer are often made of a metal having good conductivity, such as copper (Cu), nickel (Ni), or silver (Ag). On a metal pattern or a ground layer provided to a reflection panel of an electromagnetic wave reflecting device by applying a metasurface to the reflection panel, a chemical reaction product, such as rust, is caused due to the influence of oxygen or moisture. A reflective surface including a metasurface functions through its metal pattern, and the reflection angle and the reflection efficiency are determined by the surface state of the metal, the size, the shape, the arrangement, the resistance value of the unit pattern, and the like.

### SUMMARY

According to one embodiment, an electromagnetic wave reflecting device includes a reflection panel configured to reflect radio waves in a desired band selected from a band of frequencies equal to or higher than 1 GHZ and equal to or lower than 170 GHz, and a frame that holds the reflection panel, wherein the reflection panel includes: a dielectric layer; a periodic conductive pattern provided on one surface of the dielectric layer; a ground layer provided on the other surface of the dielectric layer; a first intermediate layer covering the conductive pattern; a first dielectric substrate bonded to the conductive pattern by the first intermediate layer; a second intermediate layer covering the ground layer; and a second dielectric substrate bonded to the ground layer by the second intermediate layer.

### BRIEF DESCRIPTION OF THE DRAWINGS

FIG. 1 is a schematic diagram of an electromagnetic wave reflecting fence in which a plurality of electromagnetic wave reflecting devices are joined;

FIG. 2 is a horizontal cross-sectional view of a frame taken along line A-A of FIG. 1;

FIG. 3 is a diagram illustrating a state in which a panel is inserted into the frame of FIG. 2.

FIG. 4 is a diagram illustrating an example of a layer structure of a reflection panel;

FIG. 5 is a diagram illustrating a conductive pattern model used for evaluation of reflection characteristics;

FIG. 6 is a schematic diagram illustrating a structure of a unit cell 210 of the model illustrated in FIG. 5;

FIG. 7 is a diagram illustrating an analysis space;

FIG. 8A is a schematic diagram of an XY plane of the analysis space;

FIG. 8B is a schematic diagram of an XZ plane of the analysis space;

FIG. 8C is a schematic diagram of a YZ plane of the analysis space;

FIG. 9A is a diagram illustrating a radiation pattern and an orthogonal coordinate plot of the reflection panel of Example 1 before being subjected to a durability test; and

FIG. 9B is a diagram illustrating a radiation pattern and an orthogonal coordinate plot of the reflection panel of Example 1 after being subjected to a durability test.

### DETAILED DESCRIPTION

Not limited to metasurfaces, if an electromagnetic wave reflecting device having a conductive pattern or a conductive solid film on a reflecting surface is installed indoors or outdoors for a long period of time, the surface state of the conductor changes, or scratches or aging deterioration occurs. These changes and deficiencies influence reflection of an incident electromagnetic wave; the reflection deviates from a designed direction and the reflection efficiency is therefore deteriorated. The inventor has found that if the occupancy of a conductive pattern constituting a reflective surface is lower than a certain value, the electric field is concentrated on the dielectrics around the conductive pattern, and the reflection efficiency in the designed angle and direction is deteriorated. An objective of the present invention is to provide a configuration for suppressing deterioration in reflection efficiency of an electromagnetic wave reflecting device installed indoors and outdoors.

Deterioration of the reflection efficiency of an electromagnetic wave reflecting device installed indoors and outdoors is suppressed.

In order to improve a propagation environment by using an electromagnetic wave reflecting device, it is desirable that the reflection efficiency of the electromagnetic wave reflecting device is 60% or more, preferably 70% or more. In one embodiment, in order to suppress deterioration of the reflection efficiency of the electromagnetic wave reflecting device, a conductive pattern and a ground layer provided on a reflection panel are respectively covered with intermediate layers and bonded to a dielectric substrate. A transmittance of the intermediate layer for electromagnetic waves of a frequency used is 60% or more, preferably 70% or more, and more preferably 80% or more. By keeping an area occupancy of the conductive pattern provided on the reflection panel within a predetermined range, the reflection efficiency can be improved while keeping the transmittance of the entire reflection panel at a certain level or higher.

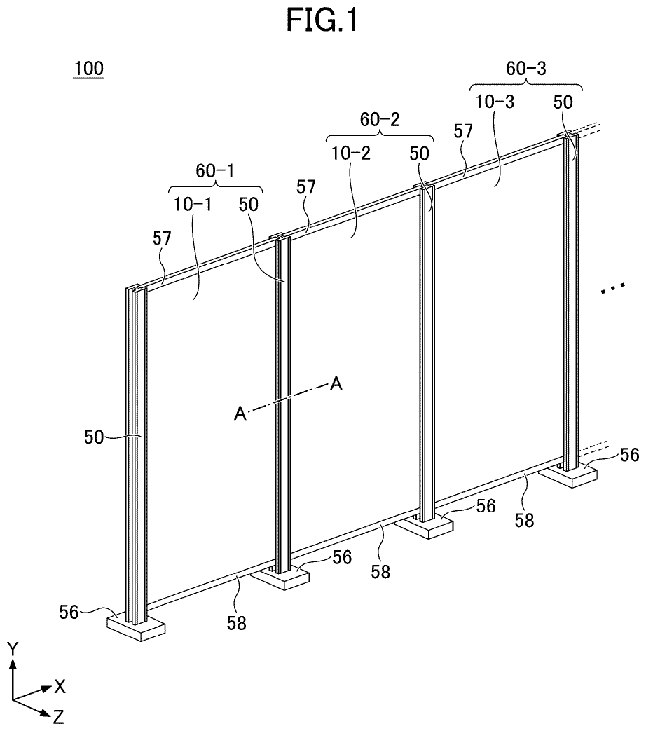

FIG. 1 is a schematic diagram of an electromagnetic wave reflecting fence 100 in which a plurality of electromagnetic wave reflecting devices 60-1, 60-2, and 60-3 are joined. Although FIG. 1 illustrates the electromagnetic wave reflecting fence 100 configured by three electromagnetic wave reflecting devices 60-1, 60-2, and 60-3 joined to each other (hereinafter, they may be collectively referred to as “electromagnetic wave reflecting devices 60” as appropriate), the number of the electromagnetic wave reflecting devices 60 to be joined is not particularly limited.

The electromagnetic wave reflecting devices 60-1, 60-2, and 60-3 include reflection panels 10-1, 10-2, and 10-3 (hereinafter, they may be collectively referred to as “reflection panels 10” as appropriate), respectively. The width direction, the height direction, and the thickness direction of the reflection panel 10 are defined as X, Y, and Z directions, respectively. Each of the reflection panels 10 reflects electromagnetic waves of 1 GHz or more and 170 GHz or less, preferably 1 GHz or more and 100 GHz or less, and more preferably 1 GHz or more and 80 GHZ or less. Each of the reflection panels 10 has, as a reflection film, a conductive pattern or a conductive film designed according to a target reflection mode, a target frequency band, or the like. The conductive film may be formed in a periodic pattern, a mesh pattern, a geometric pattern, a transparent film, or the like. Through a specific layer structure of the reflection panel, the weather resistance is improved and the deterioration of the reflection characteristics is suppressed. As will be described later, the reflection efficiency of the electromagnetic wave reflecting devices 60 is improved by keeping the occupancy of the conductive pattern in the reflective surface within a predetermined range.

Each of the reflection panels 10-1, 10-2, and 10-3 may have a specular reflection surface in which an angle of incidence and an angle of emergence of the electromagnetic wave are equal, or may be a non-specular reflection surface in which an angle of incidence and an angle of reflection are different from each other. The non-specular reflection surface includes a metasurface which is an artificial reflection surface designed to reflect radio waves in a desired direction, in addition to a diffusion surface and a scattering surface.

In some cases, from the viewpoint of maintaining continuity of a reflection potential, the reflection panels 10-1, 10-2, and 10-3 are preferably electrically connected to each other; in the case where the neighboring reflection panels 10 include a metasurface, on the other hand, electrical connections between the neighboring reflection panels 10 may be unnecessary. The neighboring reflection panels 10 are held and connected in the X direction by the frames 50, and an electromagnetic wave reflecting fence 100 is thereby obtained.

The electromagnetic wave reflecting device 60 may include legs 56 for supporting the frame 50 in addition to the reflection panel 10 and the frame 50. As illustrated in FIG. 1, in order to set the electromagnetic wave reflecting device 60 or the electromagnetic wave reflecting fence 100 upright on the installation surface, it is desirable to provide the legs 56, but the legs 56 are not essential. In addition to the frame 50, a top frame 57 for holding the upper end of the reflection panel 10 and a bottom frame 58 for holding the lower end of the reflection panel 10 may be used. In this case, the frame 50, the top frame 57, and the bottom frame 58 constitute a frame that holds the entire periphery of the reflection panel 10. The frame 50 may be referred to as a “side frame” due to its positional relationship with respect to the top frame 57 and the bottom frame 58. Provision of the top frame 57 and the bottom frame 58 ensures the mechanical strength and safety of the reflection panel 10 during transportation and assembly. Depending on purpose of use, the electromagnetic wave reflecting device 60 may be installed on a wall surface or a ceiling, with the reflection panel 10 being held by the frame 50, the top frame 57, and the bottom frame 58.

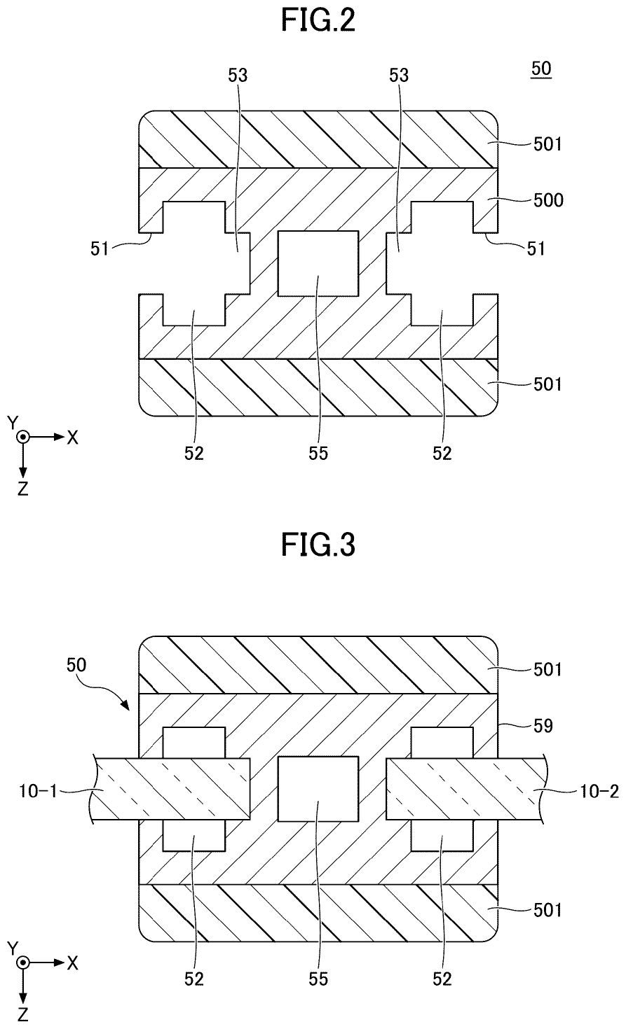

FIG. 2 is a cross-sectional view of the frame 50 taken along line A-A of FIG. 1, viewed in the section parallel to the XZ plane. The frame 50 includes a conductive main body 500 and slits 51 formed on both sides of the main body 500 in the width direction. The slits 51 hold the side edges of the reflection panel 10. The side edge of the reflection panel 10 is an edge along the Y direction in FIG. 1.

The main body 500 is provided with, on both sides, a cavity 52 communicating with the corresponding slit 51 and a groove 53 provided in the cavity 52, and with a hollow 55 not communicating with the cavities 52 and the grooves 53; however, the present invention is not limited to this example. The groove 53 is provided at a position facing the slit 51 with the cavity 52 interposed therebetween, and holds the side edge of the reflection panel 10 inserted through the slit 51. The weight of the frame 50 can be reduced by providing the cavity 52 and the hollow 55 in the frame 50. Provision of the groove 53 in the cavity 52 reinforces the retention of the reflection panel 10.

A non-conductive cover 501, such as a resin-made cover, may be provided on the outer surface of the main body 500 but the cover 501 is not essential. In the case where the cover 501 is provided, the cover 501 functions as a protection member that protects the frame 50.

FIG. 3 is a cross-sectional view parallel to the XZ plane, illustrating the state of insertion of the reflection panel 10 into the frame 50. The reflection panels 10-1 and 10-2 are inserted from the slits 51 (see FIG. 2) on both sides of the main body 500. The reflection panels 10-1 and 10-2 may or may not abut on the main body 500 by being inserted into the groove 53 (see FIG. 2) of the cavity 52 to the depth. The reflection panels 10-1 and 10-2 are inserted into the slits 51, respectively, so that the neighboring reflection panels 10-1 and 10-2 can be stably held. The main body 500 may be partially made of a non-conductive material.

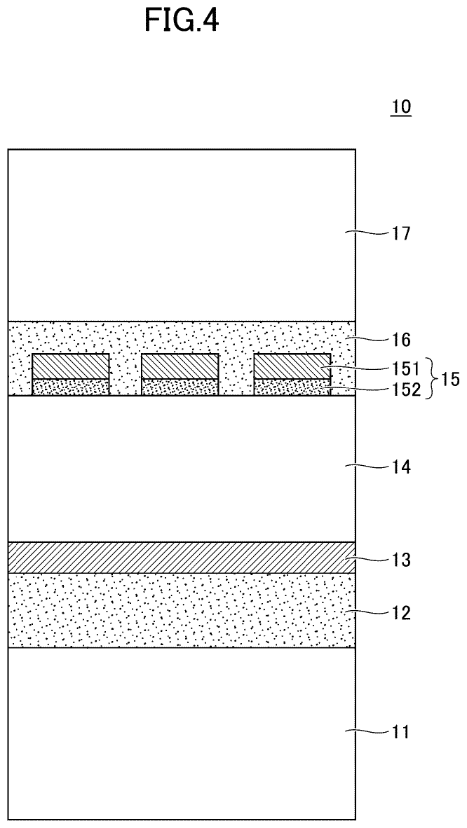

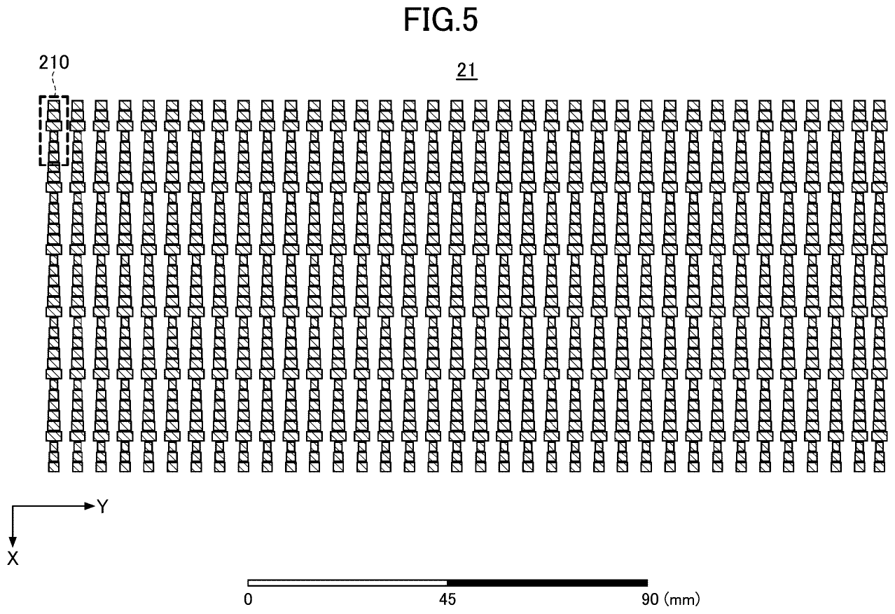

FIG. 4 illustrates an example of a layer structure of the reflection panel 10. This layer structure is a layer structure in the thickness (Z) direction of the reflection panel 10. The reflection panel 10 has a dielectric layer 14, a conductive layer 15 provided on one surface of the dielectric layer 14, a ground layer 13 provided on the other surface, a first intermediate layer 16 covering the conductive layer 15, and a second intermediate layer 12 covering the ground layer 13. The first intermediate layer 16 is an adhesive film, and the first dielectric substrate 17 is bonded to the first intermediate layer 16. The second intermediate layer 12 is an adhesive film, and the second dielectric substrate 11 is bonded to the second intermediate layer 12.

The dielectric layer 14 is an insulating polymer film such as polycarbonate, cycloolefin polymer (COP), polyethylene terephthalate (PET), or fluorine resin, and has a thickness of about 0.3 mm to 1.0 mm. The dielectric layer 14 may be made of any material having a dielectric constant and a dielectric loss tangent suitable for realizing target reflection characteristics.

The conductive layer 15 forms a reflective surface of the reflection panel 10. The reflective surface constituted by the conductive layer 15 may include a metasurface having artificially controlled reflective properties. The conductive layer 15 includes a conductive pattern 151 including a periodic pattern and an adhesive layer 152 that fixes the conductive pattern 151 to the dielectric layer 14. The conductive pattern 151 is made of a material having good conductivity, such as Cu, Ni, or Ag, and has a thickness of about 10 μm to 50 μm. The adhesive layer 152 is a material that can support the conductive pattern 151 and fix the same to the dielectric layer 14, and may be made of a thermoplastic resin, such as a vinyl acetate resin, an acrylic resin, a cellulose resin, or a silicone resin. The thickness of the adhesive layer 152 is about 5 μm to 50 μm.

The first intermediate layer 16 covering the conductive layer 15 protects the surface of the conductive layer 15 and is used for bonding the first dielectric substrate 17. The first intermediate layer 16 preferably has durability and moisture resistance, and for example, ethylene-vinyl acetate (EVA) copolymer or cycloolefin polymer (COP) can be used.

The thickness of the first intermediate layer 16 is 10 μm to 400 μm.

The first dielectric substrate 17 is bonded to the first intermediate layer 16. As the outermost layer of the reflection panel 10, the first dielectric substrate 17 is preferably made of a material having excellent impact resistance, durability, and transparency. The first dielectric substrate 17 may be made of polycarbonate, an acrylic resin, PET, or the like. The thickness of the first intermediate layer 17 is, for example, 1.0 mm to 10.0 mm.

The second intermediate layer 12 covering the conductive layer 13 protects the surface of the conductive layer 13 and is used for bonding the second dielectric substrate 11. The second intermediate layer 12 preferably has durability and moisture resistance, and for example, EVA or COP can be used. The thickness of the second intermediate layer 12 is 10 μm to 400 μm.

The second dielectric substrate 11 is bonded to the second intermediate layer 12. The second dielectric substrate 11 is preferably made of a material having excellent impact resistance, durability, and transparency as the outermost layer of the reflection panel 10. The second dielectric substrate 11 may be made of polycarbonate, an acrylic resin, PET, or the like. The thickness of the second intermediate layer 11 is, for example, 1.0 mm to 10.0 mm.

By bonding the conductive layer 15 covered with the first intermediate layer 16 to the first dielectric substrate 17, the entry of moisture and air into the surface of the conductive layer 15 is suppressed, and the surface deterioration of the conductive pattern 151 is thereby suppressed. By bonding the ground layer 13 covered with the second intermediate layer 12 to the second dielectric substrate 11, the entry of moisture and air into the surface of the ground layer 13 is suppressed, and the surface deterioration of the ground layer 13 is thereby suppressed. Accordingly, the capacitance between the ground layer 13 and the conductive pattern 151 may be maintained to be constant, and the designed magnitude of a phase delay may be thereby maintained. In other words, the reflection efficiency of the radio wave in the designed direction can be maintained.

The reflection characteristics are evaluated by changing the area occupancy of the conductive pattern 151 of the reflection panel 10 having the layer structure illustrated in FIG. 4. It is expected that the reflection efficiency will be improved as the area occupancy of the conductive pattern 151 is increased. On the other hand, in the case where the electromagnetic wave reflecting device 60 is used indoors or outdoors, such as on a road, in a park, in a factory, in a commercial facility, or in an office, it is desirable that, from the viewpoint of taking in natural light or illumination light, the reflection panel 10 has a certain degree of transparency. For this reason, a design capable of maintaining high reflection efficiency while maintaining a transmittance of 35% or more, more preferably 40%, is aimed.

FIG. 5 is a diagram illustrating a model 21 of the conductive pattern 151 used for evaluation of the reflection characteristics of the reflection panel 10. The model 21 for evaluation includes a periodic array of unit cells (also referred to as “supercells”) 210. The unit cells 210 are arranged in six rows in the X direction and 36 columns in the Y direction, and constitute a metasurface that reflects electromagnetic waves at an angle different from an angle of incidence.

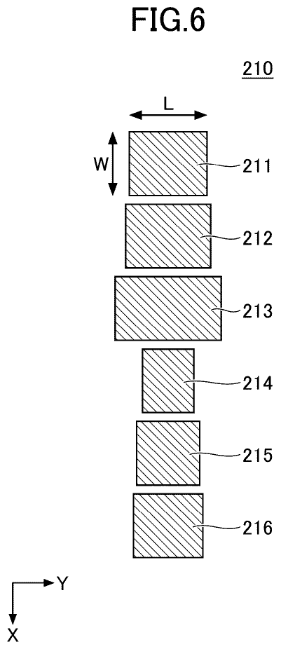

FIG. 6 is a schematic diagram illustrating the structure of the unit cell 210 of the model 21. The unit cell 210 is constituted by six metal patches 211, 212, 213, 214, 215, and 216. The width (W) direction and the length (L) direction of the metal patches 211 through 216 correspond to the width (X) direction and the height (Y) direction of the reflection panel 10 of FIG. 1, respectively. The metal patches 211 through 216 have the same width W and different lengths L but have the same central axis of the length (the Y coordinate positions of the central axis are the same). The pitch in the X direction is uniform. The phase of reflection is controlled by the shape and size of the metal patches 211 through 216, and a reflected beam is formed in a desired direction by superposition of reflected waves. In this example, each unit cell 210 is designed in such a manner that the peak of a reflected wave of a normal incidence of an electromagnetic wave (incident angle of) 0° appears in a direction of 50° from the normal.

The evaluation method is as follows: a plane wave of 28.0 GHz is made incident at an incident angle of 0° in the layer structure of FIG. 4, using the conductive pattern 151 of the model 21 of FIG. 5, and the scattering cross section of the reflected wave is analyzed by general-purpose three-dimensional electromagnetic field simulation software. The scattering cross section, namely a radar cross section (RCS), is used as an indicator of the ability to reflect incident electromagnetic waves.

For the case of a metasurface that reflects an incident wave at a reflection angle different from an angle of incidence, calculated power reflection efficiency needs to be corrected. An ideal conductive plate is perfectly specular and reflects electromagnetic waves in the same direction for normal incidence, whereas a metasurface reflects electromagnetic waves in a direction different from an angle of incidence. The power reflection efficiency of the metasurface is obtained by dividing the power reflection efficiency calculated from a gain value by a correction value.

If a reflected electric field in the metasurface without loss determined by the model pattern for simulation of FIG. 5 is E_{MR}, and a reflected electric field in the ideal conductive plate is E_{PEC}, the correction value εₚ is |E_{MR}/E_{PEC}|². |E_{MR}/E_{PEC}| can be expressed as follows:

$$\vert \frac{{E}_{MR}}{{E}_{PEC}} \vert = \frac{\sqrt{\vert cos θ \vert}}{\vert cos φ \vert} \qquad [ Math . 1 ]$$

$$or$$

$$\vert \frac{{E}_{MR}}{{E}_{PEC}} \vert = \frac{\sqrt{\vert cos {θ}_{i} \cdot cos {θ}_{r} \vert}}{\vert cos φ \vert} \qquad [ Math . 2 ]$$

where θ is an angle of incidence on the metasurface, and φ is a corresponding angle of reflection in the case of regular reflection. If the angle of reflection θ on the metasurface is 50° (or θr=) 50°, the angle of incidence θi is 0°, and the angle of reflection φ for the regular reflection is 25°, the correction value εₚ is 0.7826.

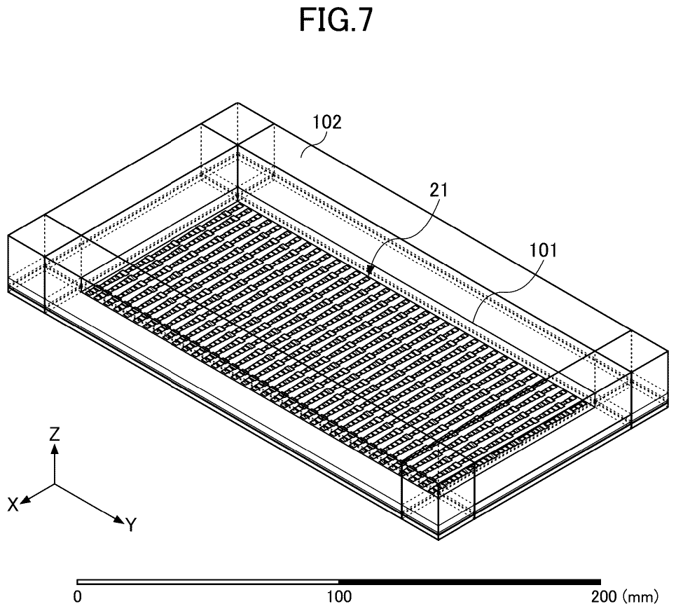

FIG. 7 shows an analysis space 101 of the electromagnetic wave simulation. Defining the thickness direction of the layer structure in FIG. 4 as the Z direction, the width direction of the metal patch of the model 21 in FIG. 5 as the X direction, and the length direction as the Y direction, the analysis space is expressed as (a dimension in the X direction)×(a dimension in the Y direction)×(a dimension in the Z direction). Suppose the dimensions of the analysis space 101 is 83.9 mm×192.6 mm×3.7 mm if the incident electromagnetic wave has a frequency of 28.0 GHz. The boundary condition is designed on an assumption that the electromagnetic wave absorber 102 is arranged around the analysis space 101.

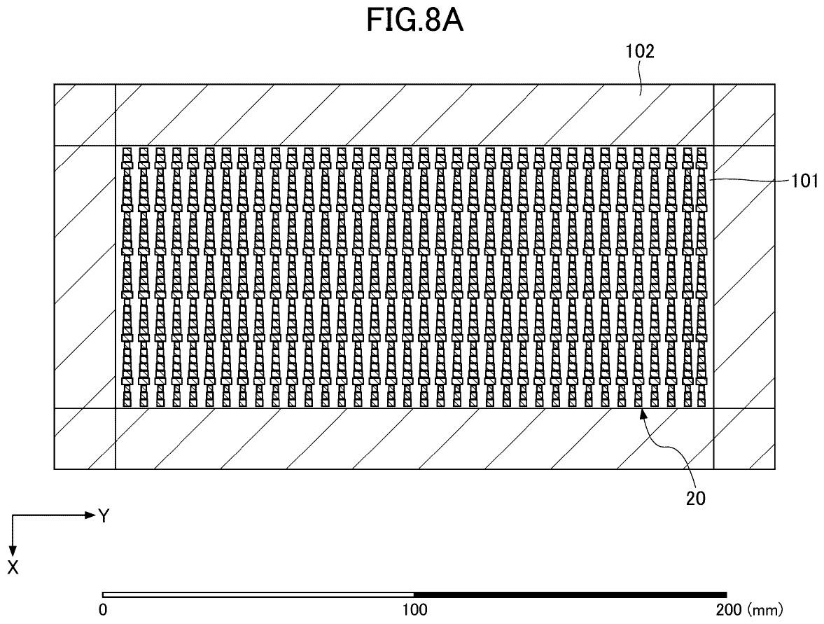

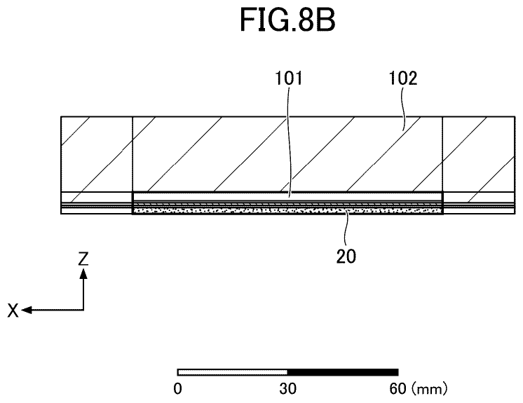

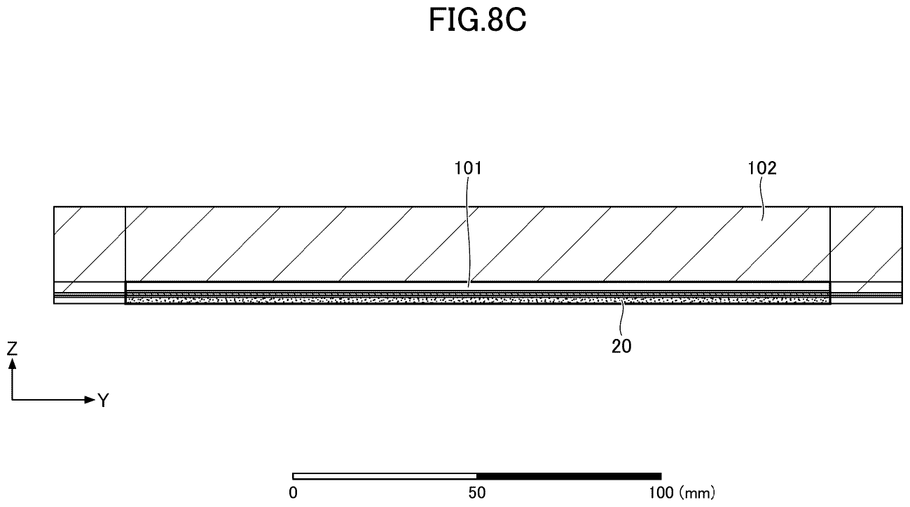

FIG. 8A is a schematic diagram of the XY plane of the analysis space 101 surrounded by the electromagnetic absorber 102, FIG. 8B is a schematic diagram of the XZ plane of the analysis space 101, and FIG. 8C is a schematic diagram of the YZ plane of the analysis space 101. In the analysis space 101, the power reflection efficiency is calculated by changing the size and the area occupancy of the metal patches of the model 21 constituting the conductive pattern 151.

### Example 1

In the layer structure of FIG. 4, a polycarbonate film having a thickness of 0.7 mm is used as the dielectric layer 14. The ground layer 13 is provided on one of the surfaces of the polycarbonate film by an Ag-based multilayer film having a thickness of 0.36 mm, and the conductive layer 15 is provided on the other surface of the polycarbonate film.

The conductive layer 15 has the conductive pattern 151 made of a copper film having a thickness of 0.03 mm formed on the adhesive layer 152 having a thickness of 0.01 mm. The shapes, namely the occupancy of the adhesive layer 152 and that of the conductive pattern 151 are the same. The intermediate layer 12 covering the ground layer 13 and the intermediate layer 16 covering the conductive layer 15 are both made of EVA having a thickness of 400 μm. A 2.0-mm polycarbonate sheet to serve as the dielectric substrates 11 and 17 is bonded to each of the intermediate layers 12 and 16.

Six metallic patches 211 through 216 of the unit cell 210 of the conductive pattern 151 are formed in a rectangular shape having a uniform width W of 0.7 mm and respective lengths L of 2.8478 mm, 3.0043 mm, 3.7000 mm, 1.7348 mm, 2.5174 mm, and 2.6925 mm. The widthwise gap between the metallic patches is uniformly 1.6283 mm. The area occupancy of the conductive pattern 151 is 15.4%, and the transmittance of the entire layer structure illustrated in FIG. 4 is 55.5%.

The gain value (a peak value of a reflected waveform) at 50° in the RCS plot in the case where a plane wave of 28.0 GHz incident at an angle of incidence of 0° is reflected at an angle of reflection of 50° is 11.5900 dB. The power reflection efficiency after correcting this gain value with the correction value εₚ=0.7826 is 78.9%. The metasurface using the conductive pattern 151 of Example 1 can achieve a power reflection efficiency of 70% or more.

The state of the reflection panel 10 having this layer structure after being left to stand in an environment of 60° C. and a humidity of 95% for 500 hours is calculated. The gain value at 50° in the RCS plot in the case where a plane wave of 28.0 GHZ incident at an angle of incidence of 0° is reflected at an angle of reflection of 50° is 11.1566 dB. The power reflection efficiency after correcting this gain value with the correction value εₚ=0.7826 is 71.4%, and the power reflection efficiency of 70% or more is maintained even after the reflection panel 10 is left in such a harsh environment for 500 hours.

### Example 2

In Example 2, the layer structure is the same as that of Example 1 but the size and the area occupancy of the conductive pattern 151 are changed from Example 1. In other words, the ground layer 13 is provided on one of the surfaces of the polycarbonate film having a thickness of 0.7 mm, which serves as the dielectric layer 14, by an Ag-based multilayer film having a thickness of 0.36 mm, and the conductive layer 15 is provided on the other surface of the polycarbonate film. The conductive layer 15 has the conductive pattern 151 made of a copper film having a thickness of 0.01 mm formed on the adhesive layer 152 having a thickness of 0.03 mm. The shapes, namely the occupancy of the adhesive layer 152 and that of the conductive pattern 151 are the same. The intermediate layer 12 covering the ground layer 13 and the intermediate layer 16 covering the conductive layer 15 are both made of EVA having a thickness of 400 μm. A 2.0-mm polycarbonate sheet to serve as the dielectric substrates 11 and 17 is bonded to each of the intermediate layers 12 and 16.

Six metallic patches 211 through 216 of the unit cell 210 of the conductive pattern 151 are formed in a rectangular shape having a uniform width W of 1.0 mm and respective lengths L of 2.8091 mm, 2.9861 mm, 3.7461 mm, 1.2505 mm, 2.3214 mm, and 2.5348 mm. The widthwise gap between the metallic patches is uniformly 1.3283 mm. The area occupancy of the conductive pattern 151 is 20.9%, and the transmittance of the entire layer structure is 51.9%.

The gain value at 50° in the RCS plot in the case where a plane wave of 28.0 GHz incident at an angle of incidence of 0° is reflected at an angle of reflection of 50° is 11.6106 dB. The power reflection efficiency after correcting this gain value with the correction value εₚ=0.7826 is 79.3%. It is understood from Example 2 that the power reflection efficiency is improved more than that of Example 1 by increasing the area occupancy in the conductive pattern 151.

### Example 3

In Example 3, the layer structure is the same as that of Examples 1 and 2, but the size and the area occupancy of the conductive pattern 151 are changed from Examples 1 and 2. In other words, the ground layer 13 is provided on one of the surfaces of the polycarbonate film having a thickness of 0.7 mm, which serves as the dielectric layer 14, by an Ag-based multilayer film having a thickness of 0.36 mm, and the conductive layer 15 is provided on the other surface of the polycarbonate film. The conductive layer 15 has the conductive pattern 151 made of a copper film having a thickness of 0.03 mm formed on an adhesive layer 152 having a thickness of 0.01 mm. The shapes, namely the occupancy of the adhesive layer 152 and that of the conductive pattern 151 are the same. The intermediate layer 12 covering the ground layer 13 and the intermediate layer 16 covering the conductive layer 15 are both made of EVA having a thickness of 400 μm. A 2.0-mm polycarbonate sheet to serve as the dielectric substrates 11 and 17 is bonded to each of the intermediate layers 12 and 16.

Six metallic patches 211 through 216 of the unit cell 210 of the conductive pattern 151 are formed in a rectangular shape having a uniform width W of 1.5 mm and respective lengths L of 2.6477 mm, 2.8607 mm, 4.0544 mm, 1.2510 mm, 2.1591 mm, and 2.3923 mm. The widthwise gap between the metallic patches is uniformly 0.8283 mm. The area occupancy of the conductive pattern 151 is 30.8%, and the transmittance of the entire layer structure is 46.0%.

The gain value at 50° in the RCS plot in the case where a plane wave of 28.0 GHz incident at an angle of incidence of 0° is reflected at an angle of reflection of 50° is 11.5595 dB. The power reflection efficiency after correcting this gain value with the correction value εₚ=0.7826 is 78.3%. It is understood from Example 3 that the power reflection efficiency is improved more than that of Example 1 by increasing the area occupancy to 30.8% in the conductive pattern 151.

### Example 4

In Example 4, the layer structure is the same as that of Examples 1 through 3, but the size and the area occupancy of the conductive pattern 151 are changed from Examples 1 through 3. In other words, the ground layer 13 is provided on one of the surfaces of the polycarbonate film having a thickness of 0.7 mm, which serves as the dielectric layer 14, by an Ag-based multilayer film having a thickness of 0.36 mm, and the conductive layer 15 is provided on the other surface of the polycarbonate film. The conductive layer 15 has the conductive pattern 151 made of a copper film having a thickness of 0.03 mm formed on an adhesive layer 152 having a thickness of 0.01 mm. The shapes, namely the occupancy of the adhesive layer 152 and that of the conductive pattern 151 are the same. The intermediate layer 12 covering the ground layer 13 and the intermediate layer 16 covering the conductive layer 15 are both made of EVA having a thickness of 400 μm. A 2.0-mm polycarbonate sheet to serve as the dielectric substrates 11 and 17 is bonded to each of the intermediate layers 12 and 16.

Six metallic patches 211 through 216 of the unit cell 210 of the conductive pattern 151 are formed in a rectangular shape having a uniform width W of 2.1 mm and respective lengths L of 2.6000 mm, 2.8354 mm, 3.5531 mm, 1.6459 mm, 2.1321 mm, and 2.3600 mm. The widthwise gap between the metallic patches is uniformly 0.2283 mm. The area occupancy of the conductive pattern 151 is 42.4%, and the transmittance of the entire layer structure is 38.8%.

The gain value at 50° in the RCS plot in the case where a plane wave of 28.0 GHz incident at an angle of incidence of 0° is reflected at an angle of reflection of 50° is 11.6908 dB. The power reflection efficiency after correcting this gain value with the correction value εₚ=0.7826 is 80.7%. It is understood from Example 4 that the power reflection efficiency is improved more than that of Examples 1 through 3 by increasing the area occupancy to 30.8% in the conductive pattern 151.

### Example 5

In Example 5, the same layer structure as that of Examples 1 through 4 and the same conductive pattern 151 as that of Example 4 are used, but the thickness of the Cu-made conductive pattern 151 supported by the adhesive layer 152 having a thickness of 0.01 mm is increased to 0.05 mm. The intermediate layer 16 covering the adhesive layer 152 and the conductive pattern 151 and the intermediate layer 12 covering the Ag-made ground layer 13 are both made of EVA having a thickness of 400 μm. A 2.0-mm polycarbonate sheet to serve as the dielectric substrates 11 and 17 is bonded to each of the intermediate layers 12 and 16.

Six metallic patches 211 through 216 of the unit cell 210 of the conductive pattern 151 are, similarly to Example 4, formed in a rectangular shape having a uniform width W of 2.1 mm and respective lengths L of 2.6000 mm, 2.8354 mm, 3.5531 mm, 1.6459 mm, 2.1321 mm, and 2.3600 mm. The widthwise gap between the metallic patches is uniformly 0.2283 mm. The area occupancy of the conductive pattern 151 is 42.4%, and the transmittance of the entire layer structure is 38.8%.

The gain value at 50° in the RCS plot in the case where a plane wave of 28.0 GHz incident at an angle of incidence of 0° is reflected at an angle of reflection of 50° is 11.7083 dB. The power reflection efficiency after correcting this gain value with the correction value εₚ=0.7826 is 81.1%. It is understood from Example 5 that the power reflection efficiency is slightly more improved than that of Example 4 by increasing the thickness of the conductive pattern to 0.05 mm while maintaining the area occupancy of the conductive pattern 151 at a sufficient level.

### Example 6

In Example 6, the same layer structure as that of Examples 1 through 5 and the same conductive pattern 151 as that of Examples 4 and 5 are used, but the thickness of the Cu-made conductive pattern 151 supported by the adhesive layer 152 having a thickness of 0.01 mm is reduced to 0.01 mm. The intermediate layer 16 covering the adhesive layer 152 and the conductive pattern 151 and the intermediate layer 12 covering the Ag-made ground layer 13 are both made of EVA having a thickness of 400 μm. A 2.0-mm polycarbonate sheet to serve as the dielectric substrates 11 and 17 is bonded to each of the intermediate layers 12 and 16.

Six metallic patches 211 through 216 of the unit cell 210 of the conductive pattern 151 are, similarly to Examples 4 and 5, formed in a rectangular shape having a uniform width W of 2.1 mm and respective lengths L of 2.6000 mm, 2.8354 mm, 3.5531 mm, 1.6459 mm, 2.1321 mm, and 2.3600 mm. The widthwise gap between the metallic patches is uniformly 0.2283 mm. The area occupancy of the conductive pattern 151 is 42.4%, and the transmittance of the entire layer structure is 38.8%.

The gain value at 50° in the RCS plot in the case where a plane wave of 28.0 GHz incident at an angle of incidence of 0° is reflected at an angle of reflection of 50° is 11.1746 dB. The power reflection efficiency after correcting this gain value with the correction value εₚ=0.7826 is 72.5%. It is understood from Example 6 that the power reflection efficiency can be maintained at 70% or more by maintaining the area occupancy of the conductive pattern 151 at a high level of 42.4%, even though thickness of the conductive pattern 151 is reduced to 0.01 mm.

### Example 7

In Example 7, the same layer structure as that of Examples 1 through 6 and the same conductive pattern 151 as that of Examples 4 through 6 are used, but the thickness of the Cu-made conductive pattern 151 supported by the adhesive layer 152 having a thickness of 0.01 mm is set to 0.03 mm, and the thickness of each of the intermediate layers 16 and 12 respectively covering the conductive pattern 151 and the ground layer 13 above and under the dielectric layer 14 to 100 μm. The intermediate layer 16 covering the adhesive layer 152 and the conductive pattern 151 and the intermediate layer 12 covering the Ag-made ground layer 13 are both made of EVA having a thickness of 100 μm. A 2.0-mm polycarbonate sheet to serve as the dielectric substrates 11 and 17 is bonded to each of the intermediate layers 12 and 16.

Six metallic patches 211 through 216 of the unit cell 210 of the conductive pattern 151 are, similarly to Examples 4 through 6, formed in a rectangular shape having a uniform width W of 2.1 mm and respective lengths L of 2.6000 mm, 2.8354 mm, 3.5531 mm, 1.6459 mm, 2.1321 mm, 2.3600 mm. The widthwise gap between the metallic patches is uniformly 0.2283 mm. The area occupancy of the conductive pattern 151 is 42.4%, and the transmittance of the entire layer structure is 38.8%.

The gain value at 50° in the RCS plot in the case where a plane wave of 28.0 GHz incident at an angle of incidence of 0° is reflected at an angle of reflection of 50° is 11.4943 dB. The power reflection efficiency after correcting this gain value with the correction value εₚ=0.7826 is 77.2%. It is understood from Example 7 that the power reflection efficiency is maintained high, even though the thickness of the conductive pattern 151 is set to 0.03 mm and the thickness of the intermediate layers 12 and 16 is reduced to some extent.

### Example 8

In Example 8, the same layer structure as that of Examples 1 through 7, the conductive pattern 151 having the same thickness and shape as those of Example 7, and the intermediate layers 16 and 12 having the same thickness as that of Example 7 are used, but the thickness of the dielectric substrates 17 and 11 bonded to the intermediate layers 16 and 12, respectively, is reduced to 1.0 mm. An EVA having a thickness of 100 μm is used as the intermediate layer 16 covering the adhesive layer 152 and the conductive pattern 151, and a polycarbonate sheet having a thickness of 1.0 mm is bonded to the intermediate layer 16. An EVA having a thickness of 100 μm is used as the intermediate layer 12 covering the Ag-made ground layer 13, and a polycarbonate sheet having a thickness of 1.0 mm is bonded to the intermediate layer 12.

Six metallic patches 211 through 216 of the unit cell 210 of the conductive pattern 151 are, similarly to Examples 4 through 7, formed in a rectangular shape having a uniform width W of 2.1 mm and respective lengths L of 2.6000 mm, 2.8354 mm, 3.5531 mm, 1.6459 mm, 2.1321 mm, and 2.3600 mm. The widthwise gap between the metallic patches is uniformly 0.2283 mm. The area occupancy of the conductive pattern 151 is 42.4%, and the transmittance of the entire layer structure is 38.8%.

The gain value at 50° in the RCS plot in the case where a plane wave of 28.0 GHz incident at an angle of incidence of 0° is reflected at an angle of reflection of 50° is 11.4943 dB. The power reflection efficiency after correcting this gain value with the correction value εₚ=0.7826 is 77.2%. It is understood from Example 8 that the reduction of the thickness of the outermost dielectric substrate to 1.0 mm does not affect the power reflection efficiency; this suggests that the intermediate layers 16 and 12 covering the conductive pattern 151 and the ground layer 13, respectively, are effective.

### Comparative Example 1

In Comparative Example 1, the same layer structure as that of Examples 1 through 4 and the conductive pattern 151 having the same thickness as that of Examples 1 through 4 are used, but the size and the area occupancy of the conductive pattern 151 are changed from Examples 1 through 4. An EVA having a thickness of 400 μm is used as the intermediate layer 16 covering the adhesive layer 152 having a thickness of 0.01 mm and the Cu-made conductive pattern 151 having a thickness of 0.03 mm, and a polycarbonate sheet having a thickness of 2.0 mm is bonded to the intermediate layer 16. An EVA having a thickness of 400 μm is used as the intermediate layer 12 covering the Ag-made ground layer 13 having a thickness of 0.36 mm, and a polycarbonate sheet having a thickness of 2.0 mm is bonded to the intermediate layer 12.

Six metallic patches 211 through 216 of the unit cell 210 of the conductive pattern 151 are formed in a rectangular shape having a uniform width W of 0.4 mm and respective lengths L of 2.9751 mm, 3.0739 mm, 3.7536 mm, 2.0344 mm, 2.7300 mm, and 2.8497 mm. The widthwise gap between the metallic patches is uniformly 1.9283 mm. The area occupancy of the conductive pattern 151 is 9.3%, and the transmittance of the entire layer structure is 59.1%.

The gain value at 50° in the RCS plot in the case where a plane wave of 28.0 GHz incident at an angle of incidence of 0° is reflected at an angle of reflection of 50° is 10.0847 dB. The power reflection efficiency after correcting this gain value with the correction value εₚ=0.7826 is 55.8%. In Comparative Example 1, the area occupancy of the conductive pattern 151 being less than 10%, the power reflection efficiency after correction becomes less than 60%, whereas the transmittance is high.

### Comparative Example 2

In Comparative Example 2, the same layer structure as that of Comparative Example 1 and the conductive pattern 151 having the same planar shape as that of Comparative Example 1 are used, but the thickness of the conductive pattern 151 is increased to 0.05 mm. Other conditions are the same as in Comparative Example 1. Six metallic patches 211 through 216 of the unit cell 210 of the conductive pattern 151 are formed in a rectangular shape having a uniform width W of 0.4 mm and respective lengths L of 2.9751 mm, 3.0739 mm, 3.7536 mm, 2.0344 mm, 2.7300 mm, and 2.8497 mm. The widthwise gap between the metallic patches is uniformly 1.9283 mm. The area occupancy of the conductive pattern 151 is 9.3% similarly to Comparative Example 1, and the transmittance of the entire layer structure is 59.1%.

The gain value at 50° in the RCS plot in the case where a plane wave of 28.0 GHz incident at an angle of incidence of 0° is reflected at an angle of reflection of 50° is 9.9986 dB. The power reflection efficiency after correcting this gain value with the correction value εₚ=0.7826 is 54.7%. In Comparative Example 2, the increase of the thickness of the conductive pattern 151 while the area occupancy of the conductive pattern 151 is less than 10% is not led to improvement in a gain or a corrected power reflection efficiency.

### Comparative Example 3

In Comparative Example 3, the same layer structure as that of Comparative Examples 1 and 2 and the conductive pattern 151 having the same planar shape as that of Comparative Examples 1 and 2 are used, but the thickness of the conductive pattern 151 is reduced to 0.001 mm. Other conditions are the same as in Comparative Example 1. Six metallic patches 211 through 216 of the unit cell 210 of the conductive pattern 151 are formed in a rectangular shape having a uniform width W of 0.4 mm and respective lengths L of 2.9751 mm, 3.0739 mm, 3.7536 mm, 2.0344 mm, 2.7300 mm, and 2.8497 mm. The widthwise gap between the metallic patches is uniformly 1.9283 mm. The area occupancy of the conductive pattern 151 is 9.3% similarly to Comparative Examples 1 and 2, and the transmittance of the entire layer structure is 59.1%.

The gain value at 50° in the RCS plot in the case where a plane wave of 28.0 GHz incident at an angle of incidence of 0° is reflected at an angle of reflection of 50° is 9.9765 dB. The power reflection efficiency after correcting this gain value with the correction value εₚ=0.7826 is 54.4%. It is understood from Comparative Example 3 that the gain and the corrected power reflection efficiency are deteriorated as a result of the reduction of the thickness of the conductive pattern 151 to 0.001 mm while the area occupancy of the conductive pattern 151 is less than 10%.

It can be understood from the results of Examples 1 through 8 and Comparative Examples 1 through 3 that the area occupancy of the conductive pattern 151 is preferably 10% or more and 45% or less, more preferably 15% or more and 45% or less in order to maintain the transmittance at 35% or more and to maintain the power reflection efficiency at 60% or more, more preferably 70% or more. The thickness of the conductive pattern 151 in this case is 0.01 mm or more and 0.05 mm or less. This is considered to be because, in the case where the area occupancy of the conductive pattern 151 becomes less than 10%, the electric fields of the incident electromagnetic wave and the reflected wave are concentrated on the surrounding dielectric, and the reflection efficiency in the designed angle and direction is deteriorated.

It suffices that the thickness of the intermediate layers 16 and 12 respectively covering the conductive pattern 151 and the ground layer 13 is a thickness that can secure moisture resistance and protection for the conductors and can bond the dielectric substrates 17 and 11, and an adhesive film having a thickness of, for example, 10 μm or more and 400 μm or less can be used. The outermost dielectric substrates 17 and 11 may be any substrates that are transparent to frequencies used, highly transparent to visible light, and highly durable, and the thicknesses thereof are preferably 1.0 mm to 5.0 mm, and more preferably 1.0 mm to 3.0 mm, so that the reflection panel 10 does not become too thick and heavy.

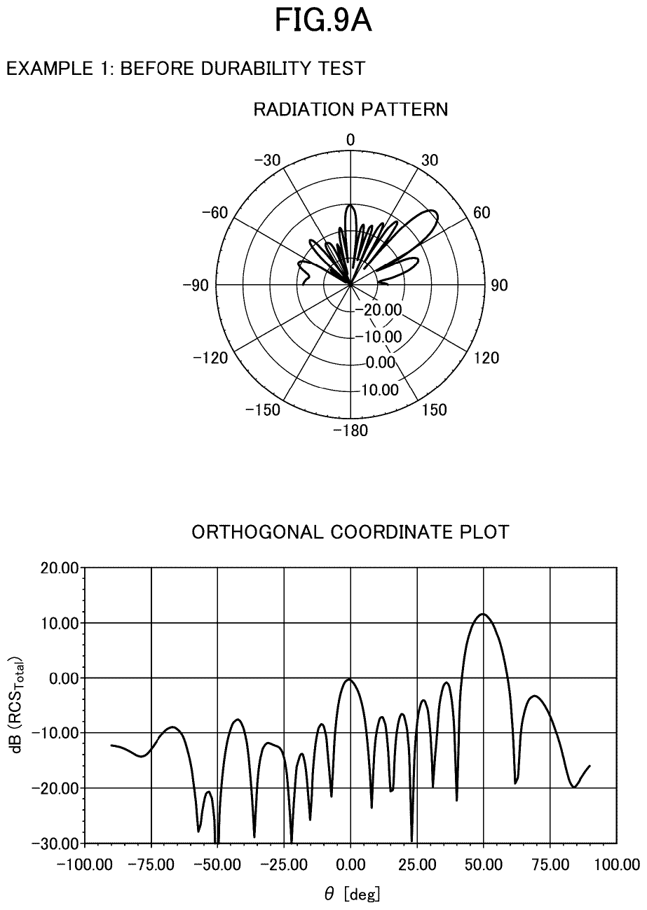

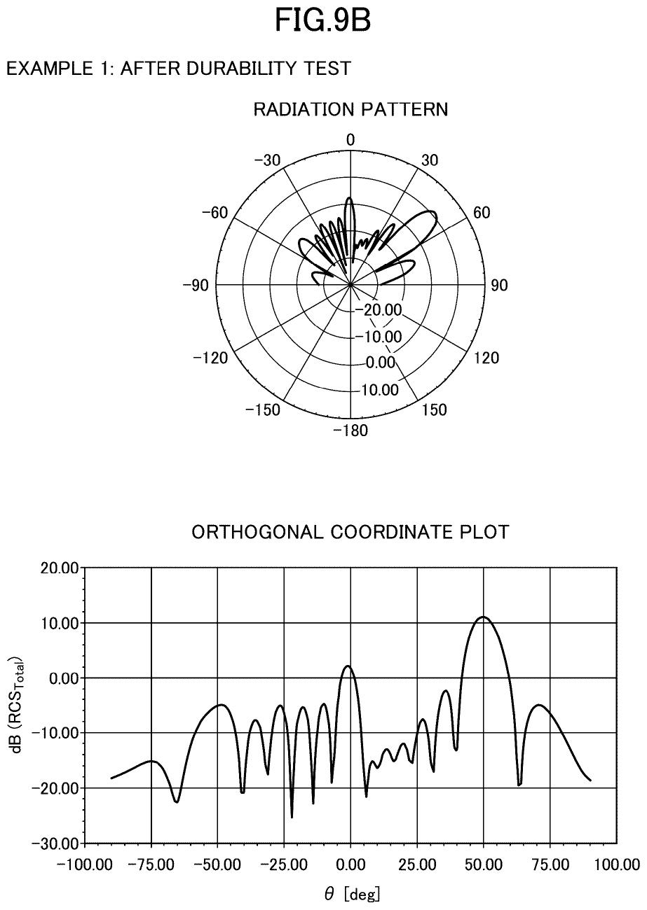

FIG. 9A is a diagram illustrating a radiation pattern and an orthogonal coordinate plot of the reflection panel 10 having the layer structure of Example 1 and being in an initial state. FIG. 9B is a diagram illustrating a radiation pattern and an orthogonal coordinate plot of the reflection panel 10 of Example 1 after being left for 500 hours in an environment where the temperature is 60° C. and the humidity is 90%. A main peak is observed in a direction of +50°, and a side peak is observed in a direction of −50° with respect to the normal incidence. The reflected radio waves cover a range of 30° to 80° in the plus direction and the minus direction with respect to the normal incidence. The radiation pattern and the peak size in the example illustrated in FIG. 9A are maintained even after the reflection panel 10 is left to stand in a harsh environment for 500 hours. The electromagnetic wave reflecting device and the electromagnetic wave reflecting fence using the reflection panel of the embodiment are excellent in the effect of improving a radio wave propagation environment and an environmental resistance, and are excellent in application under harsh environments, such as fences on highways or at construction sites.

The electromagnetic wave reflecting device of the embodiment is not limited to the foregoing configuration example. The reflection angle with respect to the normal incidence can be appropriately designed in a range of 35° or more and less than 90° by designing the size, shape, and pitch of the conductive pattern 151 and the dielectric constant of the dielectric layer 14. The in-plane size of the reflection panel 10 of the electromagnetic wave reflecting device can be selected as appropriate within a range from 30 cm×30 cm to 3 m×3 m. The entire surface of the reflection panel 10 may be a metasurface, or a part of the reflection panel 10 may be a metasurface and the remaining part may be a specular reflection surface. In this case, it is also desirable to bond the dielectric substrate to the reflective surface after covering the entire surface of the reflective surface with an adhesive film (intermediate layer) having high moisture resistance and durability. In the case where a certain degree of transmittance is required, the area occupancy of the conductive pattern 151 constituting the metasurface provided on a part or the whole of the reflective surface may be set to 10% or more and 45% or less. In a circumstance where a high level of transmittance is not required, the area occupancy of the conductive pattern 151 may be increased to be higher than 45% in order to prioritize the reflection efficiency.

What is claimed is:

1. An electromagnetic wave reflecting device, comprising:
a reflection panel configured to reflect radio waves in a desired band selected from a band of frequencies equal to or higher than 1 GHZ and equal to or lower than 170 GHz; and
a frame configured to hold the reflection panel, wherein
the reflection panel includes
a dielectric layer,
a periodic conductive pattern provided on one surface of the dielectric layer,
a ground layer provided on another surface of the dielectric layer,
a first intermediate layer covering the conductive pattern,
a first dielectric substrate bonded to the conductive pattern by the first intermediate layer,
a second intermediate layer covering the ground layer, and
a second dielectric substrate bonded to the ground layer by the second intermediate layer.

2. The electromagnetic wave reflecting device according to claim 1, wherein
an area occupancy of the conductive pattern on the one surface is 10.0% or more and 45.0% or less.

3. The electromagnetic wave reflecting device according to claim 2, wherein
a thickness of the conductive pattern is 0.01 mm or more and 0.05 mm or less.

4. The electromagnetic wave reflecting device according to claim 3, wherein
the conductive pattern is provided on the one surface while being supported by an adhesive layer.

5. The electromagnetic wave reflecting device according to claim 1, wherein
the first intermediate layer is an adhesive film having a thickness of 10 μm or more and 400 μm or less, and the first dielectric substrate is bonded by the adhesive film.

6. The electromagnetic wave reflecting device according to claim 1, wherein
the second intermediate layer is an adhesive film having a thickness of 10 μm or more and 400 μm or less, and the second dielectric substrate is bonded by the adhesive film.

7. The electromagnetic wave reflecting device according to claim 1, wherein
the frame includes
a slit into which the reflection panel is inserted,
a cavity communicating with the slit, and
a groove formed in the cavity, and
the reflection panel is held by the slit and the groove.

8. An electromagnetic wave reflecting fence, comprising:
a plurality of electromagnetic wave reflecting devices each being the electromagnetic wave reflecting device of claim 1 and being joined to each other by the frame.

9. The electromagnetic wave reflecting fence according to claim 8, wherein
at least a part of the reflection panel is a metasurface having an angle of incidence and an angle of reflection, the angle of incidence differing from the angle of reflection.

10. A reflection panel, comprising:
a dielectric layer;
a periodic conductive pattern provided on one surface of the dielectric layer;
a ground layer provided on another surface of the dielectric layer;
a first intermediate layer covering the conductive pattern;
a first dielectric substrate bonded to the conductive pattern by the first intermediate layer;
a second intermediate layer covering the ground layer; and
a second dielectric substrate bonded to the ground layer by the second intermediate layer.
